(19) United States
(12) Patent Application Publication
(10) Pub. No.: US 2015/0028161 A1
(43) Pub. Date: Jan. 29, 2015

(54) Hydraulic Passenger Lifting and Maneuvering Device

(71) Applicant: Taylor Austin Parks, Alvarado, TX (US)

(72) Inventor: Taylor Austin Parks, Alvarado, TX (US)

(73) Assignee: Taylor Austin Parks, Alvarado, TX (US)

(21) Appl. No.: 13/951,915

(22) Filed: Jul. 26, 2013

(51) Int. Cl. B64C 39/02

(52) U.S. Cl. CPC B64C 39/026
USPC 244/23 R

(57) ABSTRACT

This invention relates to a fluid driven propulsion device comprising a body arranged in a manner to facilitate flight and lift for a person, passenger or object(s) with a production of thrust from a portable or fixed power unit. A power unit is designated to move an incompressible fluid via pump through a flexible pipe or transmission tube to two or more pairs of restrictive axially offset nozzles within the embodiment of the invention allowing the incompressible fluid's pressure to build and its mass to be ejected underneath the person, passenger or object(s). This fluid is expelled with such velocity to create a force, directed into multiple, generally symmetrical force vectors, sufficient to facilitate balanced, easy to master free-flight. The invention also allows for powered, active inward and outward adjustment of the axially offset pairs of nozzles, as well as powered, active aperture adjustment of each of the nozzle outlets.

### BACKGROUND

This invention, when combined with an incompressible fluid pressure pump via a flexible fluid transmission tube is best described as a hydraulic pressure system with flow restriction at the output nozzles creating a pressure release differential and fluid mass ejection in a specific symmetrical pair vector arrangement(s). Whether the device is connected to a land based centrifugal pump powered by internal combustion or electric motor or connected to a floating jet or centrifugal style pump powered by internal combustion or electric motor is a function of operator/passenger preference. The invention in all of its embodiments provides stable level flight with very little, or no effort by the passenger in either large degree angular axial offsets as well as stable flight in small degree angular axial offsets. The invention requires no special physical skills just simply the ability of the operator to stand vertically using basic biodynamic balance in flight mode, and if controlled by manual or automatic nozzle controls will require little or no passenger balance input. The invention is directed to certain and multiple improvements in personal propulsion units as well the units propulsion newer sources, as shown for example in US 2010/0200702, “Personal Propulsion Device”, filed Apr. 26, 2010, Published Aug. 12, 2010, and U.S. Pat. No. 8,336,805 B1; Filed Jul. 24, 2012, Published Dec. 25, 2012, “Device, and System for Propelling a Passenger,” F. Zapata, as well as US 2008/0014811 A1, filed Mar. 5, 2007, Published Jan. 17, 2008, “Pull Along Power” E. Zeyger.

In one of the earliest forms of harnessed pumped fluid propulsion solutions, aforementioned US 2010/0200702 maintains the point of propulsion is at the posterior shoulder area of the operator. This configuration; albeit effective for flight, limits the operator's ability to maneuver or fly around because the bulk of the operators mass is generally below the point of propulsion. Its' primary mode of travel are up, down, and forward, and the operators hands are always on the prior art's controls. The aforementioned patent U.S. Pat. No. 8,336,805 B1, disclose a propulsion unit for individual's which comprises at least one main nozzle engaging with the bottom surface: of the platform and being positioned according than axis substantially perpendicular to said bottom surface; and two free secondary nozzles arranged to be held in the passengers hand during nominal use of the device below the centre of gravity of the “device-passenger” assembly. This design by virtue of its propulsion axis being perpendicular to the passenger' foot platform, requires secondary nozzles held in each hand of the passenger or one of the passengers to stabilize the flight via the certain described requirements of “agility and physical ability of the passenger operating the device.” In other words, the referenced, prior art solution is analogized as a table with one or two legs. The present invention is considered a table with at least four legs, more if necessary for stability.

To substantiate this embodiment's stability improvements over prior art, in EP1209076A2 filed Oct. 24, 1996 published May 29, 2002, “Hybrid Aircraft”' Both; the authors propose stable propulsive flight through a group of four thrusters, this is an unrelated but shining example of the inherent stability of the current inventions' platform. Their solution of quad thrusters is simply one for vertical takeoff and landing in close quarters through the air in a self powered vehicle, it also permits very stable flight in a forward direction by tilting the rotors forward. Additionally, US 2013/0062455A1 filed Jan. 28, 2010, Pub. Mar 14, 2013, Lugg; further conditions the current solution as a stable vertical platform citing in their claims “Also advantageously, the use of multiple electric lift fans distributed throughout the airframe of the vehicle enables the vehicle to achieve greater stability in VTOL operations than was previously possible. In the prior art, in-service VTOL aircraft have utilized only two “columns” of lift thrust both columns being in the centerline of the air craft. Again, two vs. four or more legged table.

The present invention addresses stable flight through externally sourced water pressure transmitted from a pump supply and transmission pipe. The present invention is not limited to four output nozzles, or fixed permanent nozzle locations, angles and placements. Further, the invention embodies real-time adjustability both in 2 axes of angular adjustment or adjustability in the nozzle output aperture incorporating passenger control or automatic control via software algorithms.

The solutions offered by this embodiment, regarding aforementioned patents and related art, are substantially related to operator freedom, operator control and ease of mastery because all known solutions require the operator to use high degree of physical agility and multiple modes of control input. The present invention offers a response to all the disadvantages in the known solutions. The present invention consists mainly of providing an embodiment in which the design itself implies a break with the prior solutions by completely addressing the issues of stability and safety. The four or more primary thrust nozzles of this embodiment produce axially offset pairs of thrust angle vectors offering complete stability and enhanced safety in flight, this multi-nozzle configuration below the platform eliminates the problems associated with hand control and aggressive foot control complexity of flight noted in prior art. The present invention allows the operator to completely control the platform using only foot movements keeping the hands free for any number of purposes. By virtue of its design, the present invention improves significantly, aspects regarding safety and operator endangerment through stability. In addition, the invention embodies various degrees of stability through a range of force vector arrangements. Of these, the illustrated example embodiment of axial offset pair arrangements provides static degree increments of five degrees between 15 degrees and 35 degrees. However, these degreed arrangements can be adjusted to suit any angle so long as vertical lift overcomes any high angle lateral forces.

Primarily, the passenger lifting device's uniform platform design allows normal foot position equilibrium enhancing stability by effectively locking the four jets together. Tilting the feet about the ankles provides for directional control. Rotational axis control about the vertical axis simply requires the operator to lean in one direction, or the other. Alternatively, the embodiment can allow a split board design so the operator can, with simple downward foot rotation, force the leading edge of one side of the platform down for rotational control about the primary vertical rotation axis of the invention at the power input hose connection. This allows some additional freedom and ease of control for the. passenger/operator to rotate about a vertical axis for gently turning around in place or agile quick rotations for multiple purposes.

This invention embodies personal elevated flight with extreme stability, foot controlled agility and hands free operation by virtue of its design, in one embodiment and stable lifting capability for uses other that personal flight in other embodiments. It does not singularly require a passenger's special physical ability or agility, and allows the passenger/operator many options including but not limited to the following in all of its possible embodiments.

1. Recreational use provided by floating portable pump units with sufficient power to pressurize the system with flight characteristics, including jet boats or personal watercraft such as “jet skis.”

2. The ability to master stable flight the very first time of use without time spent learning the system or special training.

3. Ease of flight providing maneuverability and stability utilizing the device's inherent stability and foot only controls.

4. The ability to lift moderately heavy objects in a stable and reliable way, if the device or load is guided manually or through remote automatic operation of adjustable nozzle arrangements in both vector angle and aperature.

5. The ability to provide a simple large stable platform for example; a crew operating offshore oil & gas production facilities, which might require lifted platform or elevation from the surface of the water.

6. Operator/Passenger configurable fluid pump sources whether land based, ship or boat based, or floating motorized pump based.

7. Operator/Passenger configurable hose lengths determined, by use of any embodiment of the invention, whether it be used in conjunction with scuba gear and a capsule for underwater exploration or with portable tools for altitude base work applications around or near any available body of water.

8. Any task which may benefit from a simple stable platform elevated above water utilizing any simple or complex arrangement of axially offset pairs of thruster nozzles, and/or adjustable output nozzles which may greatly enhance the stability of the platform for which it is intended to elevate or maneuver.

### DESCRIPTION OF THE DRAWINGS

FIG. 1 side profile of personal flight embodiment of a typically assembled device including the passenger and one sample power source view of the complete lifting propulsion unit and rider;

FIG. 2 reference perspective drawings relating to a another embodiment of the current invention illustrating a larger multi-function platform utilizing automated and semi-automated controls for the passenger.

FIG. 3 top view of a typical propulsion unit without platform portion showing a fixed axial offset pair of dual jet nozzles;

FIG. 4 is a side view of a main propulsion output nozzle, located under platform, one each side, showing an illustration of one pair of axial offset nozzles;

FIG. 5 is an exploded example of one embodiment detailing a fluid conduit connection swivel joint with an assembled, cutaway view of the fluid conduit connection swivel joint;

FIG. 6 is a perspective view of one embodiment of an assembled propulsion lifting unit in a partially swiveled position;

FIG. 7 is perspective drawing of one of the available throttle servo configurations to toggle the lever of typical available motorized water pressure unit;

FIG. 8 is a perspective view of one embodiment of a wireless hand control specifically applied to the throttle control of any fluid pump unit whether fixed or mobile;

### DETAILED DESCRIPTION OF THE INVENTION

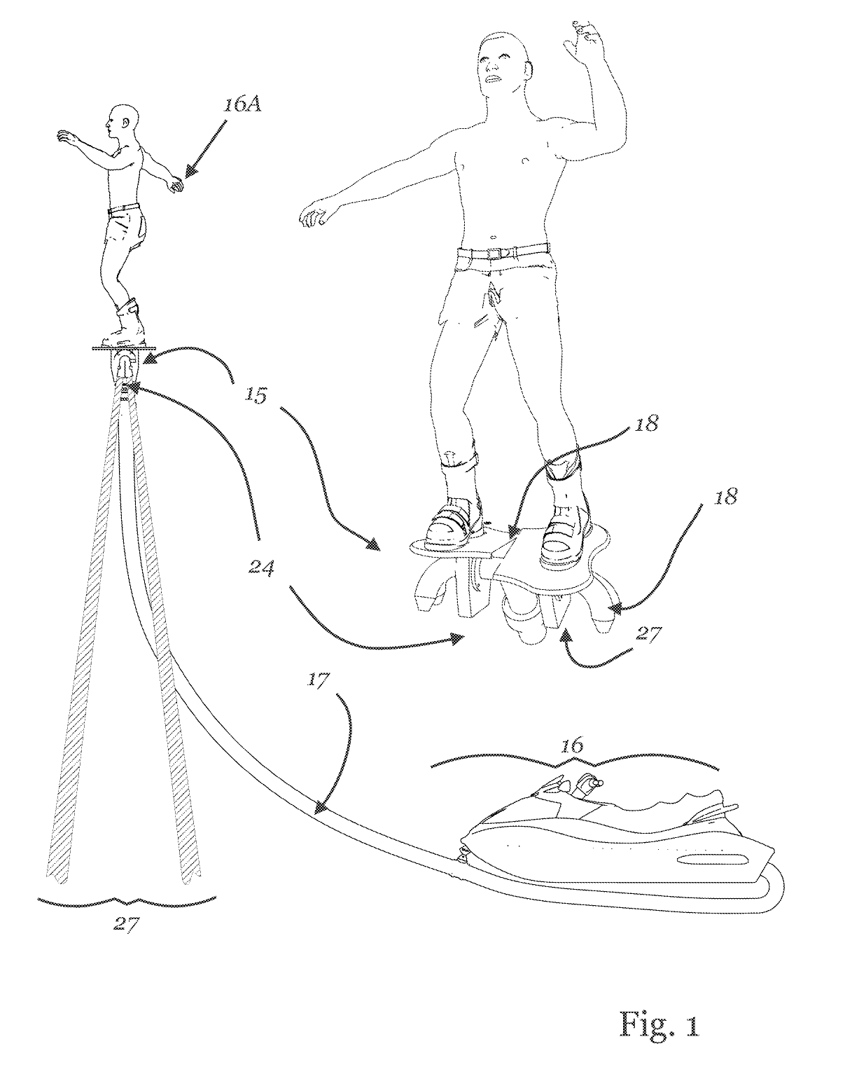

Referring now to the invention in more detail, FIG. 1 an exemplary representation of one embodiment of the present invention which provides a personal propulsion device having a platform base unit 15, availably a separate hand control unit communicating wirelessly with available power unit 16A such power unit is capable of providing pressurized fluid flow through a fluid delivery conduit 17 communicating the fluid via available motor powered output connector with the platform propulsion unit achieving stable flight through supplied water pressure from at least four points of propulsion underneath the platform 18A. Additionally, the design can incorporate a split platform for subtle control differences 18

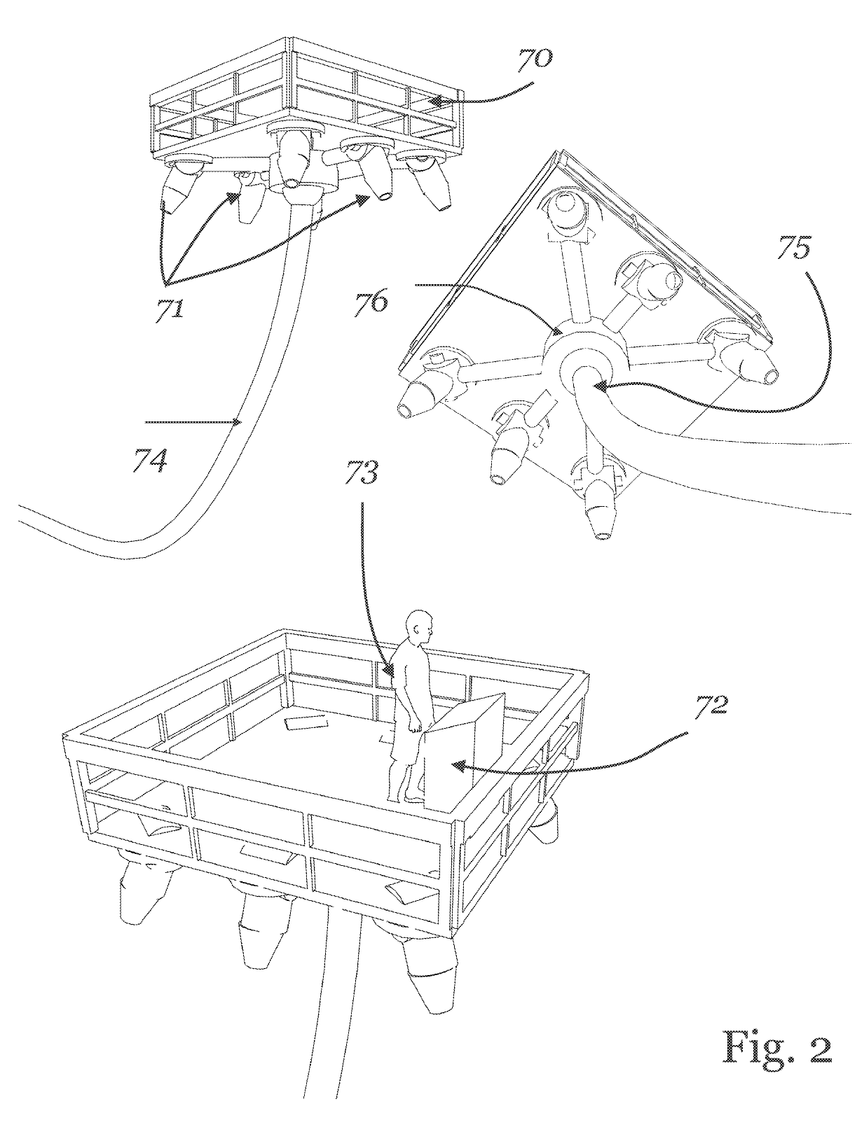

In FIG. 2, The platform main propulsion unit consists primarily of axially mounted offset vector nozzles 19 to the pressure supply conduit connection via a rotational coupling 20 which in total is designed to provide two structurally rigid axis of rotation allowing the entire platform and rider stability and ability to easily hover, spin or maneuver in such a manner facilitating controlled flight. Moreover, all of the bearing designs of the rotational coupler and “tee” connector could facilitate self lubrication and cleaning due to high water pressures inside the coupling and its particular design features which allow water to migrate through the inner cavities of the bearing assembly during use. These bearing surfaces would be constructed out of non-reactive materials facilitating longevity, corrosion resistance and reliability and easy maintenance. Further, the bearing surfaces constructed from non-corrosive metal materials interfacing with bearings which are made from FIG. 4 #22 polyvinylchloride material to aid in the manufacturing assembly process, provide extreme resistance to wear along the bearing surfaces as well as absolute corrosion resistance and by nature be inexpensive replacement parts to the operator should that need arise. The lower collar, FIG. 4 #23 which is part of the lower water conduit connection bearing assembly FIG. 4. #24 and one of the two primary axis of rotation for the whole assembly, in a threaded screw-on FIG. 4 #25a & 25b compressive fitment holds the bearing surfaces against the bearings allowing rigid one axis rotation and is held in place by recessed compression set 26 screws.

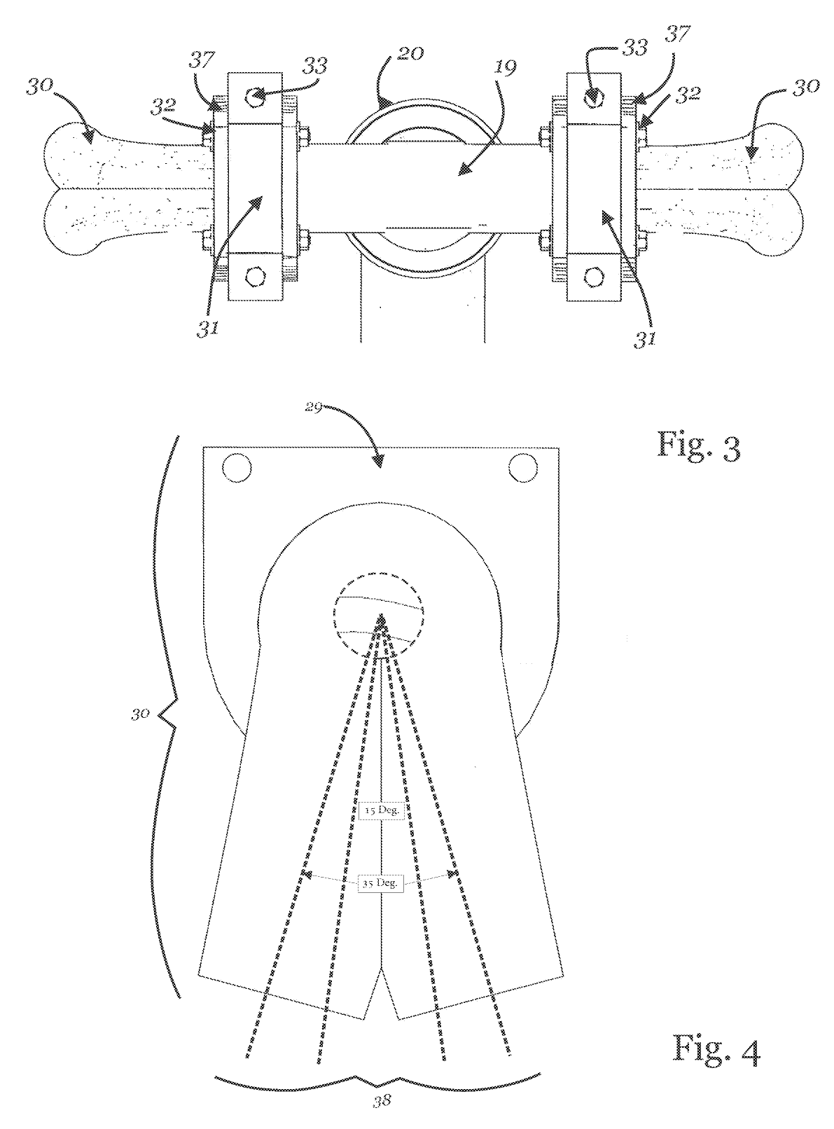

Now referring to FIGS. 2, 3, & 5 the platform assembly, the overall design features in this simplified form are demonstrated regarding the main propulsion system. This assembled platform device provides the operator the flexibility to change the angle of the main propulsion 27 nozzle thrusters relative to the operator's body weight orientation and pressure in the supply transmission tube. This is accomplished by means of the rigidly fixed condition 28 between the level surface of the platform and the four main angular output 30 nozzles. The flat and semi-circular design feature 29 of the output nozzle flange interfaces in shape with the outboard portion of the bearing support housing 31 which is firmly fastened together with 4 bolts 32 and two foot board retaining bolts 33 threaded into inserts 34 place into the bearing support housings 31 per side (left & right). The transverse or perpendicular axial rotation occurs only at the “tee” juncture bearing surfaces illustrated 35. During the ascension stage the water pressure supply transmission tube can be oriented 90 degrees native to the foot platform. As the operator overcomes the cumulative mass of himself and the assembled thrust nozzle units by applying increased throttle to the motor based power source 16A the angle of the water pressure conduit will freely change and ultimately during the flight process will drag the available power unit source over the surface FIG. 1 #16 of the water if it is a power unit source free of encumbrances or ties to fixed objects. Under this condition the operator is free to fly around tethered to the moving power unit until the water pressure power unit 16 exhausts its available fuel. The same effect seen in FIG. 8, embodied in a larger more technically complex platform 70 which can elevate larger weights and multiple persons. Stable ascention, hovering and maneuverability in this example of the invention ocurr under the same general principle of axially offset propulsion vectors. The current solution under this example would allow for powered 71 couplers and nozzle apertures to control flight via a pilot 73 or autonomously with software 72 algorithms and positioning sensors.

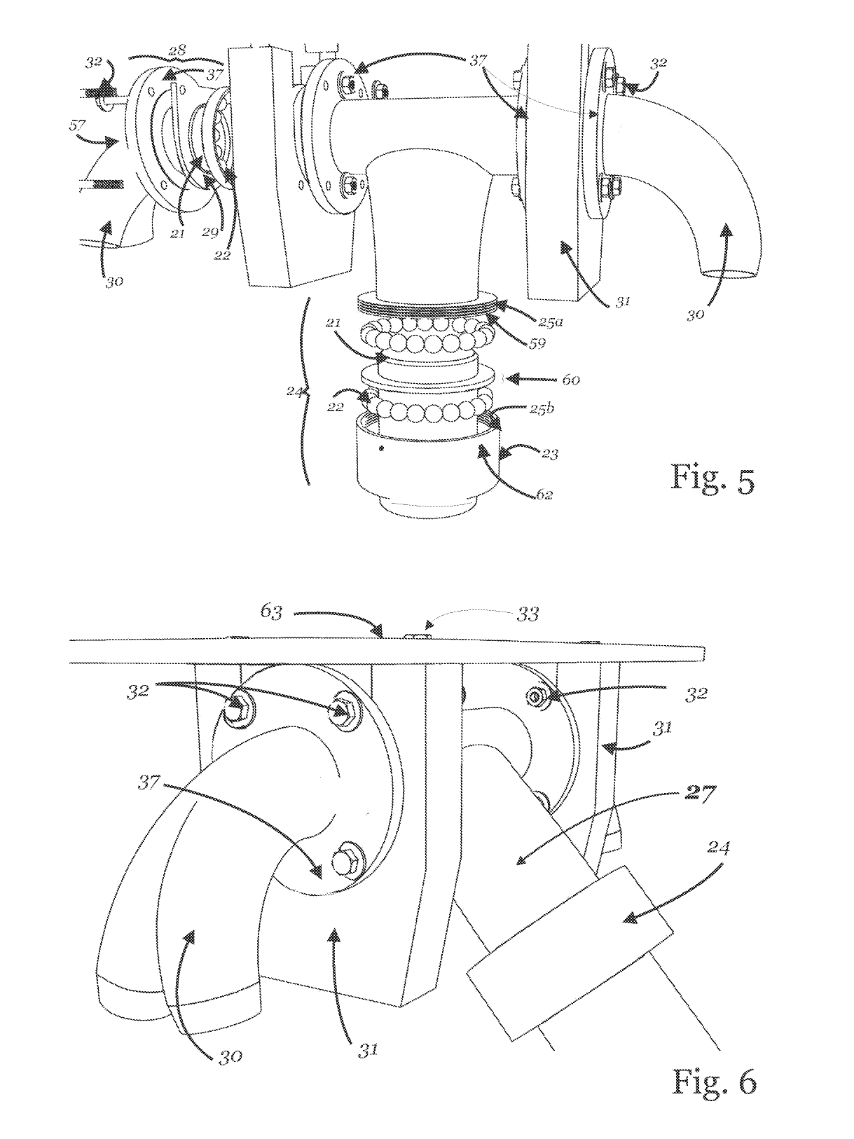

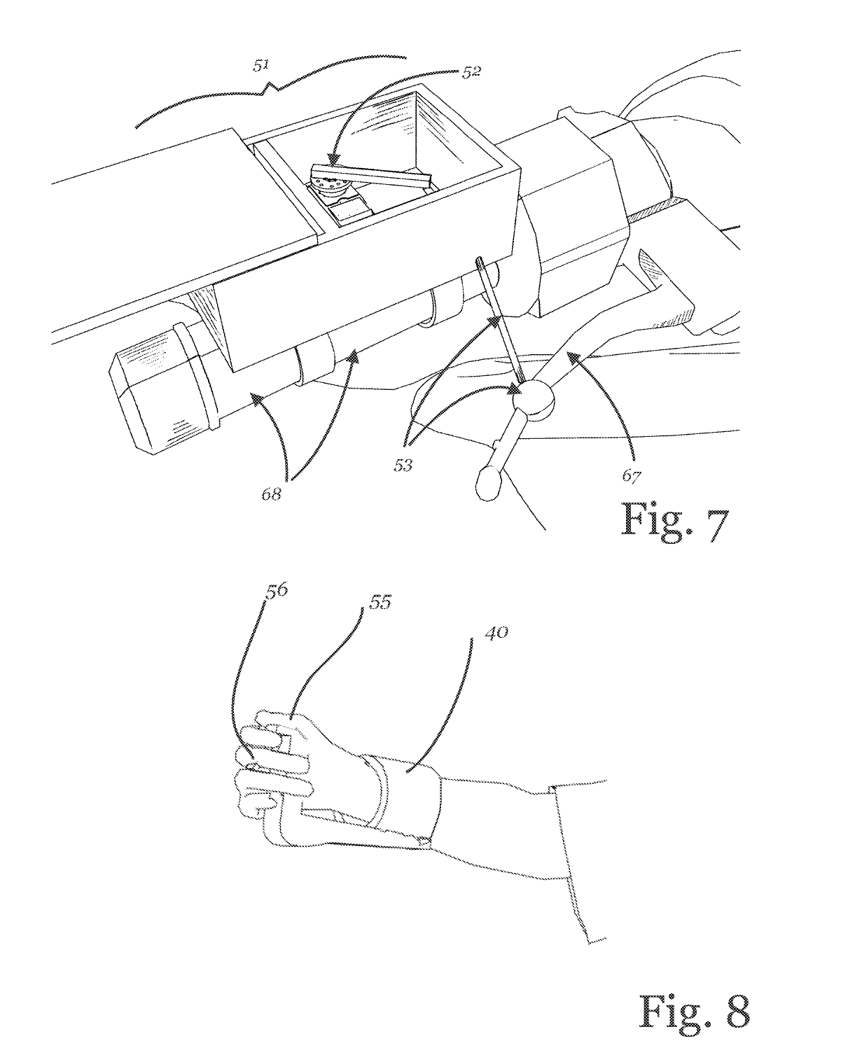

With regard to the “tee” 19 juncture bearing surfaces 35. Utilizing the same basic: design principles and characteristics as the rotational coupling 20 described previously, the bearing surfaces and bearings 35 of the axial mounted platform exhibit the same adjustability, rate of water lubrication and cleaning through compression or pressure of the water fluid passing through the conduit gaps 21 at the rotational swivel joints incorporated into the swivel couplings. These lubrication 21 design features are illustrated in FIG. 5. The bearing assemblies are contained in a solid body housing 31 made of durable ABS plastic moldings assembled in two parts. Bearings are held around the “tee” fitting output tube by bearing retainers 36 which function as additional bearing surfaces during operation. There are opposing flanges 37 which provide the necessary adjustable compressive force allowing for a wide variety of angular moments to suit the operator's preferences regarding rotational stiffness. This is accomplished by the equal torsional force on the retaining bolts 32 that hold the assembly together. Additionally the passenger platform will be split FIG. 1 #18 to accommodate subtle maneuvering enhancements by independently rotating the axially offset power nozzles from each other.

Operability of this invention is brought to fore by significant and basic design improvements over prior art by incorporating positive stability provided at least four main thrust jets FIG. 2 instead of two perpendicular jets of water. This function can be decreased or increased by changing the axial relationship 38 of the nozzle pairs 30 at the water propulsion outlets. The primary range of adjustments are defined but not limited to fifteen to thirty five degrees whereby these ranges do not affect the lifting performance & capability of the platform. The utility effect of these improvements are from the aspect of platform stability. The operator with no skill level can interchange these axial offsets and find a comfortable flight characteristic that is based on the operators' skill levels, strength levels and. height and weight parameters. No special agility or mastery of the device is required.

Because the present invention is powered by generally available, motor powered water pump and pressure units, an interface 17 & 74 to those power units is necessary for operability. This conduit provides fluid continuity and transmission from the power unit to the propulsion apparatus as well as flexible connectivity between the motor powered power unit and the propulsion apparatus.

If the need for communication between the propulsion unit and the, power unit is required FIG. 6 & 7 are facilitated by dual channel low frequency radio transmission 40 and receiver units for underwater use 51. This embodiment might use control mechanisms incorporating typical and non-typical R/C servo 52 componentry. This provides mechanical actuation of the available power units control systems hand throttle 53. On the left or right hand control of the propulsion platform hand controls are installed the electronic radio signal transmitter housed in a water proof housing 40. This componentry is fed a simple voltage variant resistance from a waterproof potentiometer assembly 55 driven by a finger actuated lever 56 incorporated into the hand grip on the left or right hand of the operator. Located in immediate proximity to the hand control throttle lever this particular embodiment may incorporate a kill switch which would allow the operator to effectively halt the available power unit's motor from operation in a fail safe manner for emergency situations should they arise.

Referring to the main conduit and propulsion device connector 20 & 75. This coupler design has two main goals; the first, provide a rigid connection between the available power unit and the propulsion device and second, provide a stable rotational axis in the vertical direction, as oriented in FIGS. 3 & 8. By design, the “tee” 19 or multi distribution arrangement 76 incorporates the simple idea of splitting the fluid distribution to the number of nozzles the design may require. The rotational aspect of lower swivel fitting is designed to occur on the upper and lower bearing surfaces swivel fitting's mating surfaces. The “tee” structure and the tubular lower swivel fitting are bezel cut and matched at their top and bottom edge surfaces respectively. If the bearings are water lubricated, flushing the bearings constantly with water will maintain a good degree of lubrication and cleanliness. The expulsion of water from this self cleaning and lubricating design feature occurs through 3 water outlet holes 62 drilled through the side surface of the screw on bearing housing collar. Under this design debris is constantly flushed allowing the bearing assemblies to be free from maintenance by the operator.

The left and right bearing units of the illustrated embodiment 35 incorporates almost identical design features as the swivel connector bearing assembly described previously. These left and right assemblies are mirrored in design 35 respectively and will be described in the following as if describing one side or the other, singularly. The consistency in design features with the swivel connector 20 bearing assembly are as follows; one, the spherical bearings utilized are the same size and material composition; two, the design incorporates gapped bezel 21 surfaces between the “tee” and the output nozzle to allow pressurized water to lubricate and flush the bearings under water pressure. There are two complete sets of spherical roller bearings and four bearing surfaces making up the assembly.

The footboard assembly or platform is primarily three main parts, incorporated as an upper flat surface 63 to facilitate personnel which the operator will place their feet during operation, handrails or seating. Once assembled, the footboard or platform and the water output pressure nozzles are incorporated in a fixed relationship to each other 28 & 70. This fixed relationship in total rotates about the long axis of the top portion of the transmission tube assembly. The lower surface of the bottom two pieces 31 of the footboard assembly also provide a base in which the whole propulsion unit assembly will rest when in use by the operator. It provides ample clearance for the water nozzle outlets to always be above and out of contact with whatever surface the power unit is placed.

Referring to FIG. 6 & 7 in the example embodiment remote. control unit are incorporated the radio control transmission circuitry which communicates with the receiver servo assembly and motor kill safety button mounted on the available water propulsion device. The hand control has a forearm brace 40 component which has Velcro type webbing to securely fasten the hand control to the lower forearm for stability, safety and comfort for the operator.

Discussed in the hand control section are overviews of the transmitter/receiver design. The following discussion deals primarily with the receiver and servo actuation of the motorized power units throttle control. Motorized power units come in many configurations both in pump style and regarding how the manufacturer chooses to control motor function with the throttle. One very consistent feature of these available motor powered water pressure source units are a human interface lever or throttle 61 mounted at the hand grip or on an human interface panel. It is this aspect of the available motor powered water pressure source unit that the present invention applies radio control servo technology to “set it and forget it” methodology. This assembly incorporates a dual channel transmitter/receiver, a servo motor with sufficient power to actuate the throttle lever on the available motor powered water pressure source unit and a linkage to connect the servo with the throttle lever on the power unit. It is set by a specified power on procedure. This complete assembly is mounted firmly to the available motor powered Water pressure source unit's hand grip 68 or human interface panel allowing for direct interface through the linkage 53 with the power units throttle lever 67. The motor kill switch is also radio controlled mechanically actuates the available motor powered water pressure source unit's kill switch with a second servo assembly attached separately to the portion of the available motor powered water pressure source units hand grip assembly.

While the foregoing written description of the invention enables one of ordinary skill to make and use what is considered presently, in this embodiment, to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as it relates to stability in flight and ease of use for any operator.

The embodiment of the invention in which an exclusive property or priviledge is claimed are defined as follows:

1. A hydraulic propulsion passenger lifting and maneuvering device rendering a stable platform for individuals, work crews or objects to become airborne comprising in combination;
a platform which is generally flat and large enough to accommodate the passenger(s) or object(s). Below the load platform, the embodiment hydraulic pressure unit system consisting of four or more fluid ejection nozzles arranged in axial offset pairs to facilitate stable and level flight with minimal effort from the passenger or operator, wherein;
the axial offset pairs of nozzles are variable in design based on variable symmetric arrangements, in degrees, defining fluid expulsion vectors to provide more stability or mote lifting power based on preference.

2. A device according to claim 1, where fluids provided by the pump unit and transmission tube to the systems arranged variable, output nozzle vectors provide all of the lifting thrust with equilibrium and stability and the amount of that fluid and pressure to the device is manually controlled at the pump source.

3. A device according to claim 1, further expanding utility of the stable platform in lifting objects wherein, the device is controlled only by varying, the amount of hydraulic power from the. pump pressurization unit.

4. A device according to claim 1, comprising two axis of rotation for operator controlled maneuverability and provides variable supply pump control through an available, wireless electronic device providing means for single operator controlled maneuverability by controlling the pump source throttle mechanisms.

5. A device according to claim 1, wherein the operator/passenger controls the maneuverability of the device through manipulation of the platform with their feet and shift of body weight.

6. A device according to claim 1, which comprises a two part platform, one side for each foot in passenger only configuration allowing for subtle controls and enhancements that further maneuverability in the vertical axis.

7. A device according to claim 1, that provides active, powered angular adjustment of the output nozzles in 2 axis both inward and outward and active powered aperture adjustment of the output nozzles for fine control and power and stability adjustments while in active flight.

8. A device according to claim 4, which provides thrust bearing linkage with a fixed or floating fluid pump, pressure unit through a flexible fluid transmission tube.

9. A device according to claim 7, which allows for live passenger adjustment of said active powered controls as if piloting, or software algorithm control for greatly simplified passenger controls.

10. A device, according to claim 7, where the transmission tube and pump arrangement can be powered by any conventional and/or available means of pumping fluids and the transmission tube can be as long as the application requires.
